(19) United States
(12) Patent Application Publication
(10) Pub. No.: US 2017/0372237 A1
(43) Pub. Date: Dec. 28, 2017

(54) SYSTEM AND METHOD FOR PRODUCING MODELS FOR ASSET MANAGEMENT FROM REQUIREMENTS

(71) Applicant: General Electric Company, Schenectady, NY (US)

(72) Inventor: Bruno Paes LEAO, Rio de Janeiro (BR)

(21) Appl. No.: 15/189,538

(22) Filed: Jun. 22, 2016

(51) Int. Cl. G06Q 10/06; G06Q 30/00

(52) U.S. Cl. CPC G06Q 10/067; G06Q 30/018

(57) ABSTRACT

According to some embodiments, a structured requirements database may store at least one electronic file containing requirements for an industrial asset, the requirements comprising a structured textual description of the industrial asset. A processing unit may access the electronic file containing the requirements for the industrial asset and automatically execute a diagnosis model creation process using the structured textual description of the industrial asset to create a model for the industrial asset. The processing unit may then transmit, via a communication port, information associated with the model to a model based diagnosis engine.

### BACKGROUND

It may be desirable to manage an industrial asset, or “monitored system,” by diagnosing faults that might occur in connection operation of the asset. To facilitate this monitoring, an asset-specific diagnosis system may receive evidence (e.g., sensed by sensors during operation of the asset) and automatically generate an indication of a likelihood of fault occurrence along with one or more potential causes of the fault. To allow the system to monitor multiple assets (or multiple types of assets) a generic diagnosis system may receive evidence and use a monitored system model to generate an indication of a likelihood of fault occurrence along with one or more potential causes of the fault. In some cases, an expert with knowledge about an industrial asset may generate system rules (e.g., if X and Y, then Z) to create an appropriate monitored system model for that particular asset. Similarly, knowledge about an industrial asset may be used in a component model creation process to generate a model that can be used via a model based diagnosis system to monitor that asset. The creation of such models, however, can be a time-consuming, expensive, and error prone process—especially when an industrial asset is complex and/or there are a substantial number of sources of information (e.g., sensors) and/or types of fault that may occur. It would therefore be desirable to provide systems and methods to facilitate a creation of monitored system models for industrial assets based on structured requirements in an automatic and accurate manner.

### SUMMARY

According to some embodiments, a structured requirements database may store at least one electronic file containing requirements for the industrial asset, the requirements comprising a structured textual description of the industrial asset. A processing unit may access the electronic file containing the requirements for the industrial asset and automatically execute a diagnosis model creation process using the structured textual description of the industrial asset to create a model for the industrial asset. The processing unit may then transmit, via a communication port, information associated with the model to a model based diagnosis engine.

Some embodiments comprise: means for storing in a structured requirements database at least one electronic file containing requirements for the industrial asset, the requirements comprising a structured textual description of the industrial asset; means for accessing, by a processing unit coupled to the structured requirements database, the electronic file containing the requirements for the industrial asset; means for automatically executing a diagnosis model creation process using the structured textual description of the industrial asset to create a for the industrial asset; and means for transmitting, via a communication port coupled to the processing unit, information associated with the to a model based diagnosis engine.

Some technical advantages of some embodiments disclosed herein are improved systems and methods to create model for an industrial asset based on structured requirements in an automatic and accurate manner.

### BRIEF DESCRIPTION OF THE DRAWINGS

FIG. 1 is a high-level architecture of a system in accordance with some embodiments.

FIG. 2 illustrates a method that might be performed according to some embodiments.

FIG. 3 illustrates an aviation asset management system in accordance with some embodiments.

FIG. 4 is an example of a model based diagnosis according to some embodiments.

FIG. 5 illustrates information associated with a structured requirements database in accordance with some embodiments.

FIG. 6 illustrates an interactive graphical user interface display according to some embodiments.

FIG. 7 is block diagram of a diagnosis model creation platform according to some embodiments of the present invention.

FIG. 8 is a tabular portion of a structured requirements database according to some embodiments.

FIG. 9 illustrates an interactive handheld graphical user interface display according to some embodiments.

### DETAILED DESCRIPTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

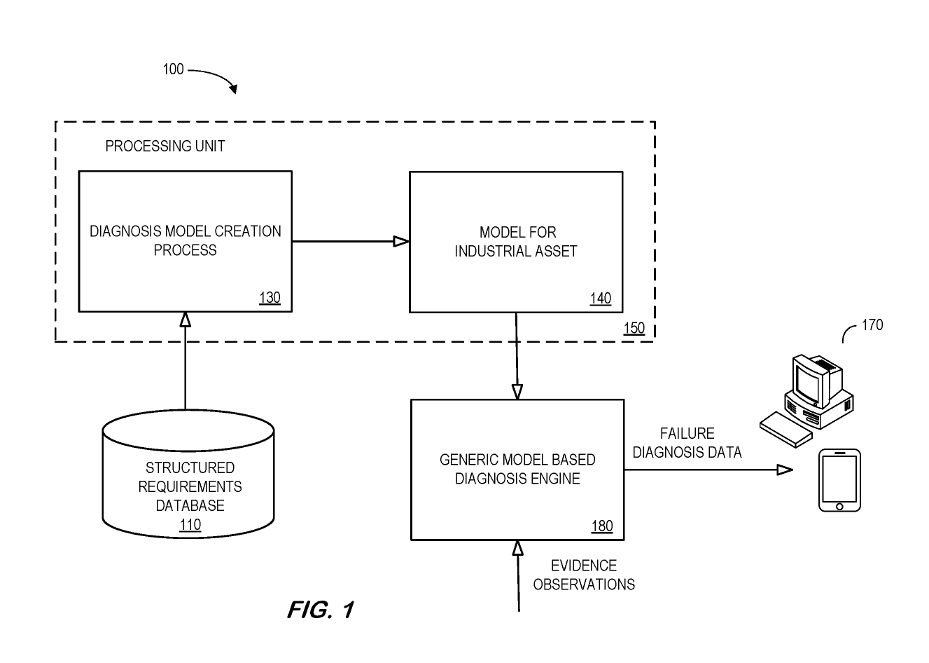

FIG. 1 is a high-level architecture of a system 100 in accordance with some embodiments. The system 100 includes a structured requirements database 110 that provides information to a processing unit 150. Data in the structured requirements database 110 might include, for example, one or more electronic files containing a structured textual description of the industrial asset.

The processing unit 150 may, according to some embodiments, access the structured requirements database 110, and utilize a diagnosis model creation process 130 to automatically create a model 140 for an industrial asset. The asset model 140 may then be used by a generic model based diagnosis engine 180 to generate failure diagnosis data based on evidenced observations (e.g., data sensed by sensors proximate to the industrial asset). The failure diagnoses data might comprise, for example, alert messages that are transmitted to remote operator platforms 170 to let an operator managing the asset take repair or maintenance actions as appropriate. As used herein, the term “automatically” may refer to, for example, actions that can be performed with little or no human intervention.

As used herein, devices, including those associated with the processing unit 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The processing unit 150 may store information into and/or retrieve information from various data sources, such as the structured requirements database 110 and/or operator platforms 170. The various data sources may be locally stored or reside remote from the processing unit 150. Although a single processing unit 150 is shown in FIG. 1, any number of such devices may be included. Moreover, various devices described herein might be combined according to embodiments of the present invention. For example, in some embodiments, the processing unit 150 and one or more data sources might comprise a single apparatus. The processing unit 150 function may be performed by a constellation of networked apparatuses, in a distributed processing or cloud-based architecture.

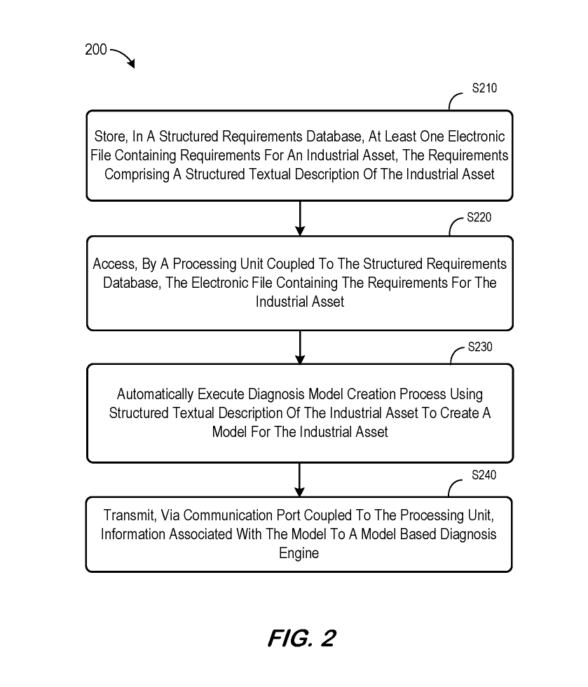

A user may access the system 100 via one of the user platforms 170 (e.g., a personal computer, tablet, or smartphone) to view or edit information about and/or manage the model 140 in accordance with any of the embodiments described herein. According to some embodiments, an interactive graphical display interface may let an operator define and/or adjust certain parameters, provide or receive automatically generated recommendations (e.g., to industrial asset behavior), and/or interact with the model based diagnosis engine 180. For example, FIG. 2 illustrates a method 200 that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, at least one electronic file containing requirements for the industrial asset may be stored in a structured requirements database. The requirements may, according to some embodiments, comprise a structured textual description of the industrial asset. As used herein, the term textual might refer to, for example, a formal naming and definition of the types, properties, and/or interrelationships of the entities that exist in connection with an industrial asset. The textual description may comprise ontologies which may for example, compartmentalize variables needed for some set of computations and establish the relationships between them. According to some embodiments, the requirements document is associated with a validation and verification automation, such as a validation and verification automation associated with an aviation system. At S220, a processing unit, coupled to the structured requirements database, may access the electronic file containing the requirements for the industrial asset.

At S230, the system may automatically execute a diagnosis model creation process using the structured textual description of the industrial asset to create a model for the industrial asset. The diagnosis model creation process may, for example, extract information from textual feature elements of the structured textual description. According to some embodiments, the structured requirements define a plurality of components of the industrial asset and, for each component, appropriate input and output signals and this information is used to create system models for the components.

At S240, a communication port coupled to the processing unit may be used to transmit information associated with the model to a model based diagnosis engine. The model based diagnosis engine may, for example, receive evidence observations and provide failure diagnosis data. According to some embodiments, the model based diagnosis engine is associated with a generic diagnosis system of a central maintenance computer system and the failure diagnosis data includes a likelihood of fault occurrence for the industrial asset. In some cases, the failure diagnosis data may further include indications of fault causes or troubleshooting guidance.

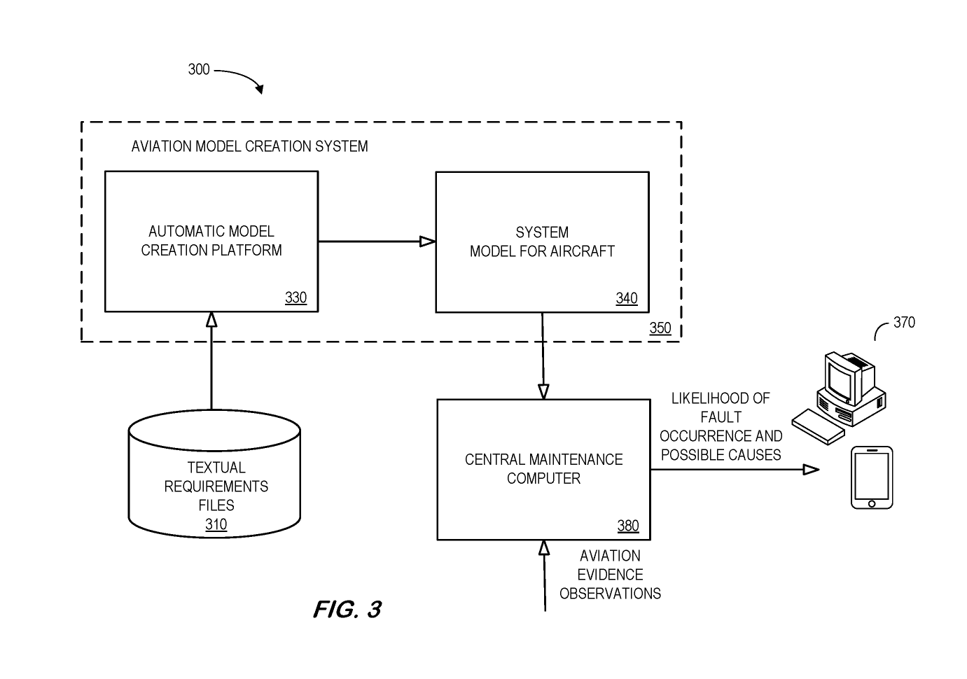

FIG. 3 illustrates an aviation asset management system 300 in accordance with some embodiments. As before, the system 300 includes textual requirements files 310 that provide information to an aviation model creation system 350. Data in the textual requirements files 310 might include, for example, one or more electronic files containing a structured textual description of an airplane, airplane engine, aircraft system, etc.

The aviation model creation system 350 may, according to some embodiments, access the textual requirements files 310, and utilize an automatic model creation platform 330 to automatically create model 340 for aircraft systems or components. The asset model 340 may then be used by a central maintenance computer 380 to generate failure diagnosis data based on aviation evidenced observations (e.g., data sensed by sensors in the airplane). The failure diagnoses data might comprise, for example, alert messages that are transmitted to remote operator platforms 370 to let an operator managing the airplane take repair or maintenance actions as appropriate. As used herein, devices, including those associated with the aviation model creation system 350 and any other device described herein, may exchange information via any communication network.

The aviation model creation system 350 may store information into and/or retrieve information from various data sources, such as the structured requirements files 310 and/or operator platforms 370. The various data sources may be locally stored or reside remote from the aviation model creation system 350. Although a single aviation model creation system 350 is shown in FIG. 3, any number of such devices may be included. Moreover, various devices described herein might be combined according to embodiments of the present invention. For example, in some embodiments, the aviation model creation system 350 and one or more data sources might comprise a single apparatus. The aviation model creation system 350 function may be performed by a constellation of networked apparatuses, in a distributed processing or cloud-based architecture.

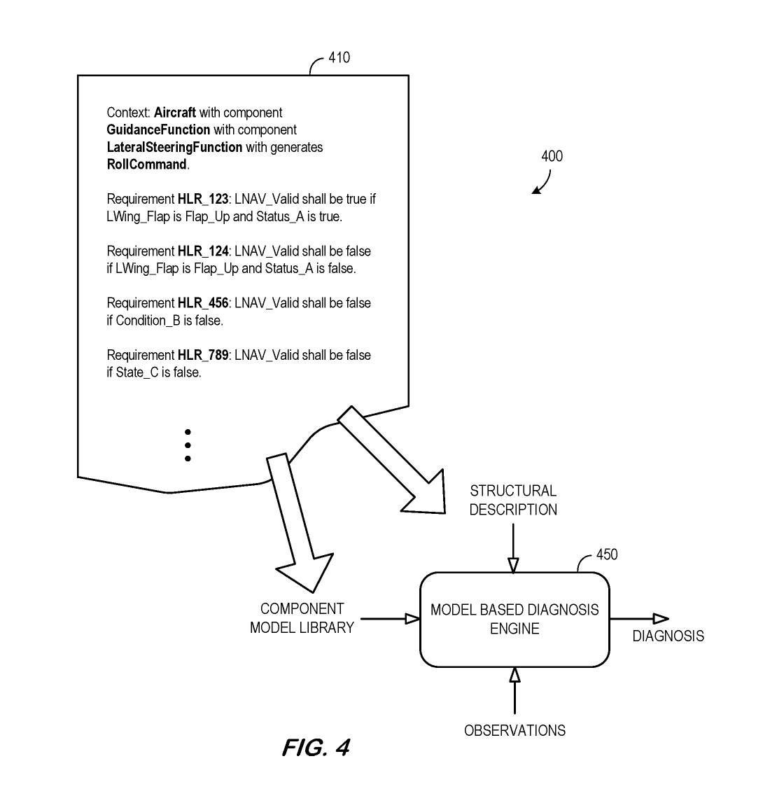

FIG. 4 is an example 400 of a model based diagnosis according to some embodiments. In particular, a structured requirements file 410 contains textual feature elements of a structured textual description of an industrial asset. For example, variable LNAV_Valid equals “true” when LWing_Flap is “Flap_Up” and “Status_A” equals “true,” etc. The structured requirements file 410 may be used to create a structural description and/or a component model library that may be provided to a model based diagnosis engine 450. The model based diagnosis engine 450 may then use this information to generate a diagnosis based on observations from an industrial asset (e.g., data from sensors associated with an aircraft).

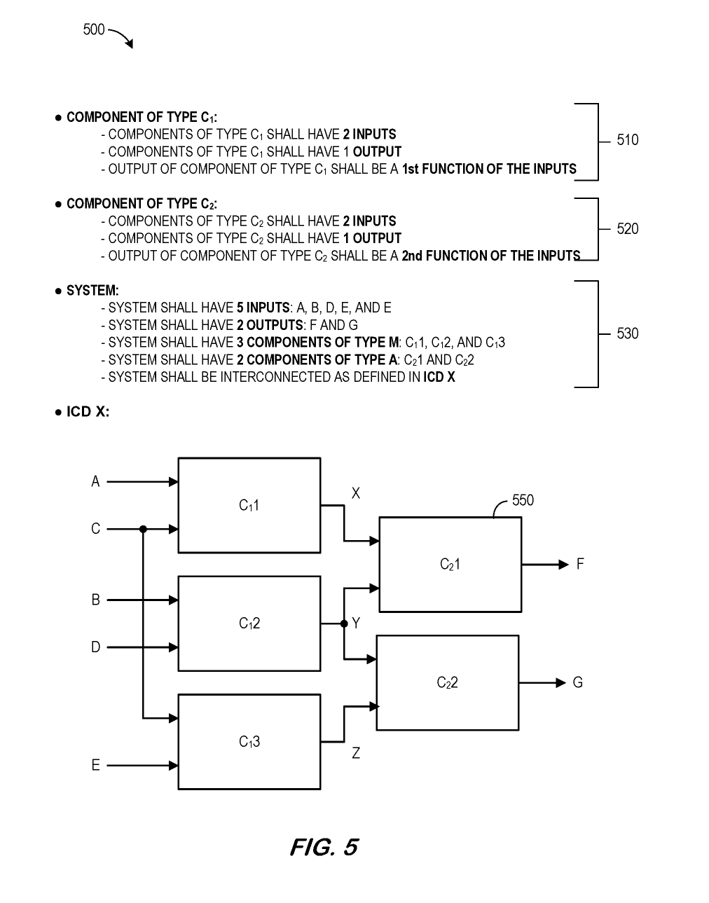

FIG. 5 illustrates information 500 associated with a structured requirements database in accordance with some embodiments. The information 500 includes a definition of component type “C₁” (e.g., an OR gate, an AND gate, an adder, or multiplier) 510. In particular, the definition of component type C₁ 510 indicates that each component has two inputs and one output representing a first function of the two inputs. The information 500 also includes a definition of component type “C₂” 520. In particular, the definition of component type C₂ 520 indicates that each component has two inputs and one output representing a second function of the two inputs.

The information 500 further includes a system level description 530. The system level description 530 indicates that system will have five inputs (A, B, C, D, and E), two outputs (F and G), three components of type “C₁” (C₁1, C₁2, and C₁3), and two components of type “C₂” (C₂1 and C₂2). Moreover, the system level description 530 indicates that the system will be interconnected in accordance with Interface Coordination Document (“ICD”) X 550 (illustrated in FIG. 5). This information 500 may then be used to create a model for an industrial asset in accordance with any of the embodiments described herein (e.g., a failure of input A might result in a specific occurrence at outputs F and G, etc.).

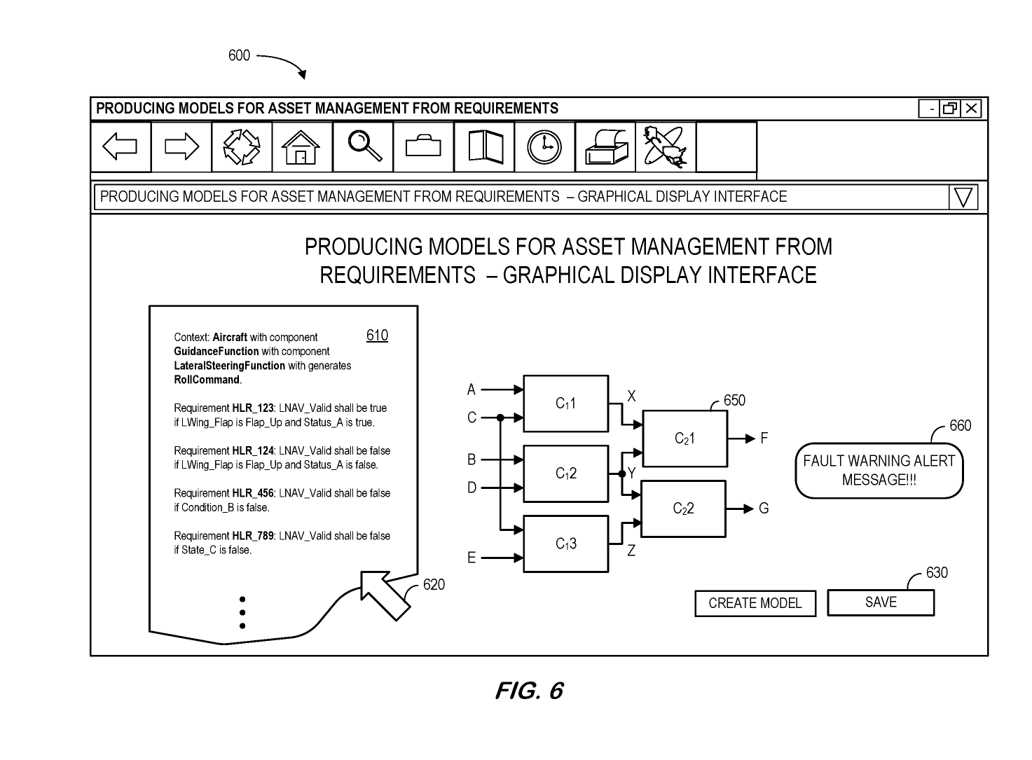

FIG. 6 illustrates an interactive graphical user interface display 600 according to some embodiments. The display 600 may include a graphical representation of structured requirements 610. The display 600 may be interactive, for example, in that an operator might use a computer icon or mouse pointer 620 to select the structural requirements 610 to receive more information about that element (or any other element on the display). For example, according to some embodiments the display might further include user-selectable icons 630 to let an operator create a model, save data, etc. The display 600 may further include graphical representations of a model or interconnection dictionary 650 along with one or more diagnosis indications 660 (e.g., generated via a model based diagnosis system).

Note that some embodiments described herein may be developed based upon two building blocks: Model Based Diagnosis (also referred to as “MBD”) and automatic Validation and Verification (also referred to as “V&V”) technologies. As used herein, the phrase “model based diagnosis” may refer to a technology in which computational models of assets or systems are employed to perform failure diagnosis. Once available, such models can be employed using generic model based diagnosis frameworks which can be developed, for example, based on theorem provers. Model based diagnosis systems may be especially useful in a scenario of complex interacting systems, such as an aircraft. In this case, it may be especially difficult to manually build rules for failure diagnosis. Building a model of each component, or piece of the system, and integrating those models to yield diagnosis information may be a more effective approach.

Technologies for automating validation and verification may be useful in aviation systems as a result of costs associated with developing embedded software. The automated validation and verification may include structured representation of requirements and the automatic manipulation of the structures. According to some embodiments, tools provided for the purpose of validation and verification automation (or spin-offs from those) may be used to automatically produce (or at least partially produce) models that can be employed for a model based verification task. As a result, the models creation task for model based diagnosis may become much more efficient and effective. Thus, embodiments described herein may automate the process of creating models for failure diagnosis based on structured requirements information.

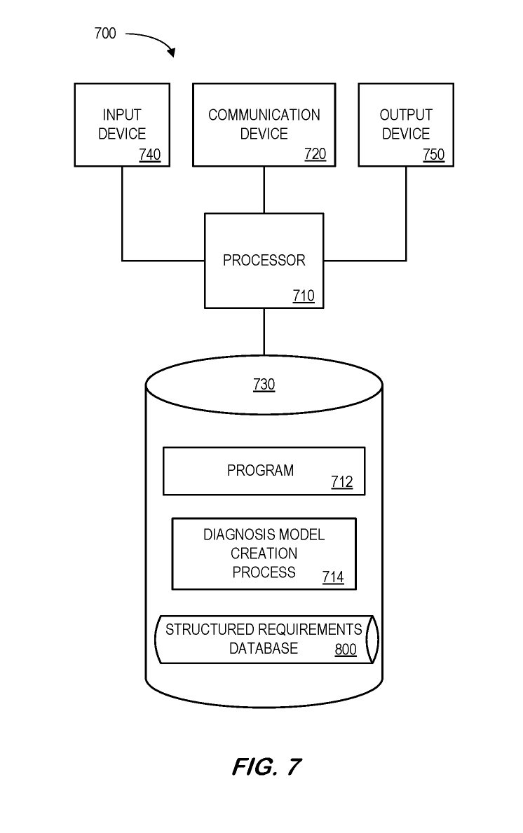

The embodiments described herein may be implemented using any number of different hardware configurations. For example, FIG. 7 is block diagram of a diagnosis model creation platform 700 that may be, for example, associated with the system 100 of FIG. 1 and/or the system 300 of FIG. 3. The diagnosis model creation platform 700 comprises a processor 710, such as one or more commercially available Central Processing Units (“CPUs”) in the form of one-chip microprocessors, coupled to a communication device 720 configured to communicate via a communication network (not shown in FIG. 7). The communication device 720 may be used to communicate, for example, with one or more remote operator platforms. The diagnosis model creation platform 700 further includes an input device 740 (e.g., a computer mouse and/or keyboard to input modeling information) and/an output device 750 (e.g., a computer monitor to render displays, transmit recommendations, and/or create reports). According to some embodiments, a mobile device, cloud-based application, and/or PC may be used to exchange information with the diagnosis model creation platform 700.

The processor 710 also communicates with a storage device 730. The storage device 730 may comprise any appropriate information storage device, including combinations of magnetic storage devices (e.g., a hard disk drive), optical storage devices, mobile telephones, and/or semiconductor memory devices. The storage device 730 stores a program 712 and/or a diagnosis model creation process 714 for controlling the processor 710. The processor 710 performs instructions of the programs 712, 714, and thereby operates in accordance with any of the embodiments described herein. For example, the processor 710 may access a structured requirements database that stores at least one electronic file containing requirements for the industrial asset, the requirements comprising a structured textual description of the industrial asset. The processor 710 may automatically execute a diagnosis model creation process using the structured textual description of the industrial asset to create a model for the industrial asset. The processor 710 may then transmit, via the communication device 720, information associated with the model to a model based diagnosis engine.

The programs 712, 714 may be stored in a compressed, uncompiled and/or encrypted format. The programs 712, 714 may furthermore include other program elements, such as an operating system, clipboard application, a database management system, and/or device drivers used by the processor 710 to interface with peripheral devices.

As used herein, information may be “received” by or “transmitted” to, for example: (i) the diagnosis model creation platform 700 from another device; or (ii) a software application or module within the diagnosis model creation platform 700 from another software application, module, or any other source.

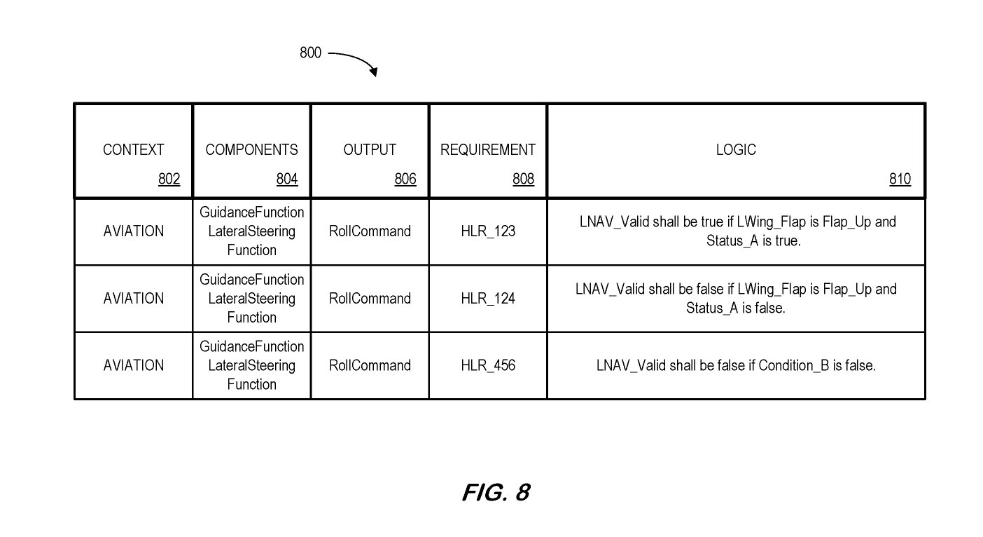

In some embodiments (such as the one shown in FIG. 7), the storage device 730 further stores structured requirements database 800. An example of a database that may be used in connection with the diagnosis model creation platform 700 will now be described in detail with respect to FIG. 8. Note that the database described herein is only one example, and additional and/or different information may be stored therein. Moreover, various databases might be split or combined in accordance with any of the embodiments described herein.

Referring to FIG. 8, a table is shown that represents the structured requirements database 800 that may be stored at the diagnosis model creation platform 700 according to some embodiments. The table may include, for example, entries identifying components, inputs, outputs, interconnections, and/or logic associated with an industrial asset. The table may also define fields 802, 804, 806, 808, 810 for each of the entries. The fields 802, 804, 806, 808, 810 may, according to some embodiments, specify: a context 802, components 804, output 806, requirement 808, and logic 810. The structured requirements database 800 may be created and updated, for example, when data is imported into the system, a new airplane or engine is to be modeled, etc.

The context 802 may be, for example, a unique alphanumeric code identifying a particular type of industrial asset (e.g., an “aviation” asset). The components 804 and the output 806 may define an element of the system. For example, GuidanceFunction and LateralSteeringFunction might output RollCommand as illustrated in FIG. 8. The requirement 808 might comprise, for example, a unique alphanumeric code identifying a particular piece of logic 810 to be associated with the components 804 and/or output 806. For example, LNAV_Valid should be set to “false” when LWing_Flap equals “Flap_Up” and Status_A is equal to “false” as illustrated in FIG. 8. The information in the structured requirements database may then be used to automatically create an integrated monitored system model according to any of the embodiments described herein.

Thus, some embodiments may provide an automatic and efficient way to create a model for an industrial asset based on structured requirements in an accurate manner. Some embodiments described herein may provide simpler and more cost effective development of means for diagnosing faults in aircraft and other industrial assets. This can benefit directly, for example, a designer of aircraft engines and systems. Embodiments might also be sold as a framework to aircraft Original Equipment Manufacturers (“OEMs”). For example, such a framework may simplify and make more effective the OEMs processes of developing Onboard Maintenance System logic.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

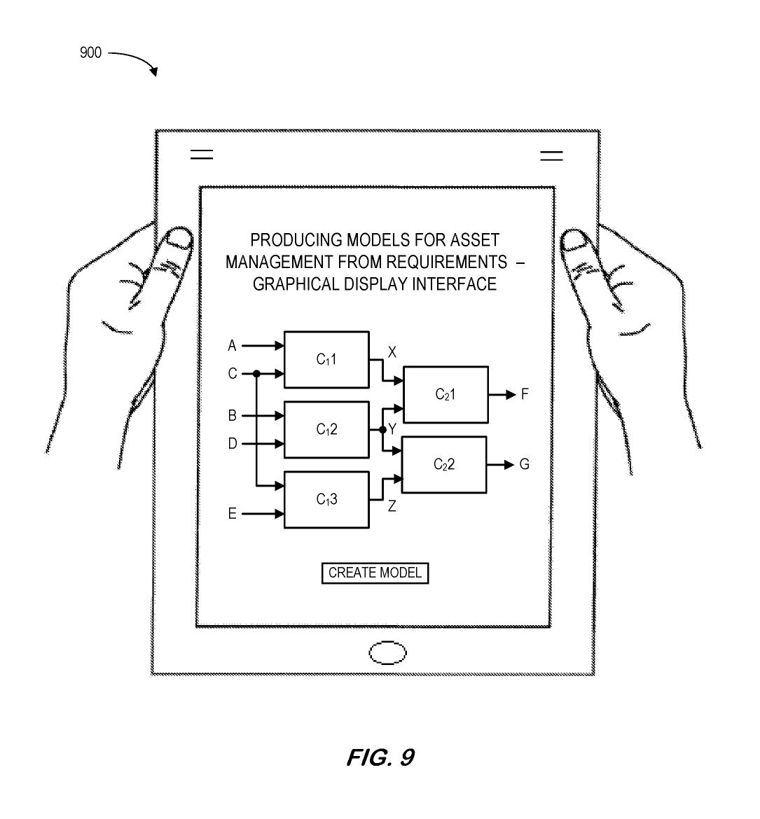

Although specific hardware and data configurations have been described herein, note that any number of other configurations may be provided in accordance with embodiments of the present invention (e.g., some of the information associated with the databases described herein may be combined or stored in external systems). For example, although some embodiments are focused on aircraft systems, embodiments might be associated with power plants, locomotives, or any other type of industrial asset. Moreover, although sample displays have been provided as illustrations, note that embodiments might utilize any other type of display, including virtual reality, augmented reality, and mobile computers. For example, FIG. 9 illustrates an interactive handheld graphical user interface display 900 according to some embodiments. The display 900 might provide, for example, a graphical representation of an integrated monitored system model in accordance with any of the embodiments described herein.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system associated with management of an industrial asset, comprising:
a structured requirements database storing at least one electronic file containing requirements for the industrial asset, the requirements comprising a structured textual description of the industrial asset;
a processing unit, coupled to the structured requirements database, to:
access the electronic file containing the requirements for the industrial asset, and
automatically execute a diagnosis model creation process using the structured textual description of the industrial asset to create a model for the industrial asset; and
a communication port coupled to the processing unit to transmit information associated with the model to a model based diagnosis engine.

2. The system of claim 1, wherein the requirements are associated with a validation and verification automation.

3. The system of claim 2, wherein the validation and verification automation is associated with an aviation system.

4. The system of claim 3, wherein the diagnosis model creation process extracts information from textual feature elements of the structured textual description.

5. The system of claim 2, wherein the requirements define a plurality of components of the industrial asset and, for each component, appropriate input and output signals that are used to create models for the components.

6. The system of claim 1, wherein model based diagnosis engine is to receive evidence observations and to provide failure diagnosis data.

7. The system of claim 6, wherein the model based diagnosis engine is associated with a generic diagnosis system of a central maintenance computer system.

8. The system of claim 7, wherein the failure diagnosis data includes a likelihood of fault occurrence for the industrial asset.

9. The system of claim 8, wherein the failure diagnosis data further includes indications of fault causes.

10. A method associated with management of an industrial asset, comprising:
storing in a structured requirements database at least one electronic file containing requirements for the industrial asset, the requirements comprising a structured textual description of the industrial asset;
accessing, by a processing unit coupled to the structured requirements database, the electronic file containing the requirements for the industrial asset;
automatically executing a diagnosis model creation process using the structured textual description of the industrial asset to create model for the industrial asset; and
transmitting, via a communication port coupled to the processing unit, information associated with the model to a model based diagnosis engine.

11. The method of claim 10, wherein the requirements are associated with a validation and verification automation.

12. The method of claim 11, wherein the validation and verification automation is associated with an aviation method.

13. The method of claim 12, wherein the diagnosis model creation process extracts information from textual feature elements of the structured textual description.

14. The method of claim 11, wherein the requirements define a plurality of components of the industrial asset and, for each component, appropriate input and output signals that are used to create models for the components.

15. The method of claim 10, wherein model based diagnosis engine is to receive evidence observations and to provide failure diagnosis data.

16. The method of claim 15, wherein the model based diagnosis engine is associated with a generic diagnosis method of a central maintenance computer method.

17. The method of claim 16, wherein the failure diagnosis data includes a likelihood of fault occurrence for the industrial asset.

18. The method of claim 17, wherein the failure diagnosis data further includes indications of fault causes.

19. A system associated with management of an industrial asset, comprising:
a structured requirements database storing at least one electronic file containing requirements for the industrial asset, the requirements comprising a structured textual description of the industrial asset, including a plurality of components of the industrial asset and, for each component, appropriate input and output signals;
a diagnosis model creation process including a processing unit, coupled to the structured requirements database, to:
access the electronic file containing the requirements for the industrial asset,
extract information from textual feature elements of the structured textual description,
automatically execute a diagnosis model creation process using the structured textual description of the industrial asset to create a model for the industrial asset, and
transmit, via a communication port coupled to the processing unit, information associated with the model to a model based diagnosis engine; and
the model based diagnosis engine to:
receive evidence observations,
execute a generic diagnosis system of a central maintenance computer system in accordance with the model, and
provide failure diagnosis data, including a likelihood of fault occurrence for the industrial asset along with indications of fault cause.

20. The system of claim 19, wherein the requirements are associated with a validation and verification automation associated with an aviation system.
